(19) United States
(12) Patent Application Publication
(10) Pub. No.: US 2026/0302652 A1
(43) Pub. Date: Oct. 1, 2026

(54) ANTENNA ASSEMBLY MOUNTED ON VEHICLE

(71) Applicant: LG ELECTRONICS INC., Seoul (KR)

(72) Inventors: Changil KIM, Seoul (KR); Changwon YUN, Seoul (KR); Yeomin YOUN, Seoul (KR); Kibong JUNG, Seoul (KR); Yongkon KIM, Seoul (KR)

(73) Assignee: LG ELECTRONICS INC., Seoul (KR)

(21) Appl. No.: 19/477,014

(22) PCT Filed: Jul. 19, 2023
(86) PCT No.: PCT/KR2023/010368

§ 371 Date: Oct. 20, 2025

(51) Int. Cl. H01Q 21/30; H01Q 1/32; H01Q 9/42

(52) U.S. Cl. CPC H01Q 21/30; H01Q 1/3275; H01Q 9/42

(57) ABSTRACT

Provided is an antenna assembly mounted on a vehicle, according to an embodiment. The antenna assembly comprises: a first housing; a second housing; a PCB on which electronic components are arranged; a first antenna unit disposed between the first housing and the PCB and connected to a first point on a first surface of the PCB; and a second antenna unit disposed between the second housing and the PCB and connected to a second point on a second surface of the PCB. The first point and the second point may be connected by a via.

### TECHNICAL FIELD

The present disclosure relates to an antenna assembly mounted on a vehicle. A particular implementation relates to an antenna assembly having a wideband antenna and a vehicle having the antenna assembly.

### BACKGROUND ART

As technology advances from 4G (LTE) to 5G communications, automotive antennas have also continuously required network expandability from general FM/AM antennas and LTE antennas to 5G antennas or V2X antennas.

With beginning of 5G communication on a full scale, vehicle antennas have been also expanding from general FM/AM, LTE (4G), and global navigation satellite system (GNSS) communication antennas to antennas for 5G Sub6 and V2X communications that support high frequencies. Accordingly, the vehicle antennas may also be expanded variously to shark fin antennas, in-dash antennas, in-spoiler antennas, and side-mirror type antennas by taking into account performance, design, and network expandability.

Meanwhile, a vehicle body and a vehicle roof are made of metallic materials, which causes such a problem that radio waves are blocked. Accordingly, a separate antenna structure may be placed on the vehicle body or the vehicle roof. Alternatively, when an antenna structure is arranged on a bottom of the vehicle body or roof, a portion of the vehicle body or the vehicle roof corresponding to a region where the antenna structure is arranged may be made of a non-metallic material.

However, in terms of design, the vehicle body or the vehicle roof needs to be integrally arranged. In this case, an exterior of the vehicle body or roof may be made of a metallic material. This may cause significant antenna performance deterioration caused by the vehicle body or the vehicle roof.

Additionally, there is a problem in that it is difficult to implement antennas mounted on a vehicle to operate in multiple frequency bands.

### Disclosure of Invention

### Technical Problem

Therefore, to obviate those problems, an objective of this specification is to resolve antenna performance deterioration caused by a vehicle body or roof.

Another objective of this specification is to maintain antenna performance at a certain level even when exterior of a vehicle body or roof is made of a metal material.

Another objective of this specification is to enhance antenna performance while maintaining a height of an antenna assembly at a certain level or less.

Another objective of this specification is to provide an antenna assembly to allow to perform wideband operation in multiple frequency bands.

Another objective of this specification is to optimize parameters of an antenna arranged on a region of the vehicle roof while taking into account antenna gains and frequency characteristics.

### Solution to Problem

To achieve these and other advantages and in accordance with the purpose of the present disclosure, as embodied and broadly described herein, there is provided an antenna assembly mounted on a vehicle according to an embodiment. The antenna assembly may include: a first housing; a second housing; a printed circuit board (PCB) on which electronic components are arranged; a first antenna unit arranged between the first housing and the PCB and connected to a first point on a first surface of the PCB; and a second antenna unit arranged between the second housing and the PCB and connected to a second point on a second surface of the PCB. The first point and the second point may be connected to each other by a via.

According to an embodiment, the first antenna unit may include a conductive pattern arranged inwardly from an end portion of the PCB to be parallel with the PCB; and a connection pattern connected to an end portion of the conductive pattern and an end portion of the PCB and arranged vertically to the PCB.

According to an embodiment, the first antenna unit may include: a dielectric carrier having one side surface and a front surface; a conductive pattern located on the front surface of the dielectric carrier and arranged inwardly from an end portion of the PCB to be parallel with the PCB; and a connection pattern arranged on the one side surface of the dielectric carrier, arranged vertically to the PCB, and connecting an end portion of the conductive pattern to an end portion of the PCB.

According to an embodiment, the second antenna unit may include: a second dielectric carrier having one side surface and a rear surface; and a second conductive pattern arranged on the rear surface of the second dielectric carrier. The first antenna unit may constitute a first carrier antenna unit, and the second antenna unit may constitute a second carrier antenna unit.

According to an embodiment, the first antenna unit may include: a first connection pattern connected to the first point and extending in a vertical axis direction; a second connection pattern connected to a third point on the first surface of the PCB and extending in the vertical axis direction; and the conductive pattern connected to the first connection pattern and the second connection pattern and arranged in parallel with the PCB.

According to an embodiment, the first antenna unit may include: a first connection pattern connected to the first point and extending in a horizontal axis direction; a second connection pattern connected to a third point on the first surface of the PCB and extending in the horizontal axis direction; a third connection pattern connected to an end portion of the first connection pattern and an end portion of the second connection pattern each extending in the horizontal axis direction, and extending in a vertical axis direction; a fourth connection pattern connected to the end portion of the first connection pattern and the end portion of the second connection pattern and having a loop shape defined on a plane thereof vertical to the PCB; and the conductive pattern connected to the third connection pattern and arranged in parallel with the PCB.

According to an embodiment, the antenna assembly may further include a third antenna unit arranged between the second housing and the PCB and configured to radiate a wireless signal in a fourth frequency band higher than the second frequency band.

### Advantageous Effects of Invention

The technical effects of an antenna assembly mounted on such a vehicle and the vehicle mounted with the antenna assembly are described as follows.

According to this specification, a gap distance between a first antenna unit arranged in a region on the PCB and a metal structure may be adjusted to resolve antenna performance deterioration caused by a vehicle body or roof.

According to this specification, a gap distance between the first antenna unit and the metal structure and a width and a height of the first antenna unit may be adjusted to maintain antenna performance at a certain level even when exterior of the vehicle body or roof is made of a metal material.

According to this specification, an antenna gain may be maintained at a certain level or greater while minimizing a gap distance between the first antenna unit and the metal structure to thereby enhance antenna performance while maintaining a height of the antenna assembly at a certain level or less.

According to this specification, the first to third antenna units may be arranged in regions on and below the PCB, respectively, so that the antenna assembly may operate in multiple frequency bands for 4G/5G communications and Wi-Fi frequency bands.

According to this specification, a gap distance, and a width and a height of the first antenna unit may be implemented to have threshold values or less to thereby optimize parameters of an antenna arranged on a region of the vehicle roof while taking into account antenna gains and frequency characteristics.

Further scope of applicability of the present disclosure will become apparent from the following detailed description. It should be understood, however, that the detailed description and specific examples, such as the preferred embodiment of the present disclosure, are given by way of illustration only, since various changes and modifications within the idea and scope of the present disclosure will be apparent to those skilled in the art.

### BRIEF DESCRIPTION OF DRAWINGS

FIG. 1 is a diagram illustrating a vehicle according to an embodiment of this specification.

FIGS. 2A to 2B illustrate a structure in which an antenna assembly may be mounted on a vehicle according to this specification, wherein the vehicle includes the antenna assembly.

FIG. 3 is a configuration diagram of a vehicle according to an embodiment of this specification.

FIG. 4 is an exploded view of the antenna assembly mounted on the vehicle according to this specification.

FIG. 5 is a side view of the antenna assembly having first and second antenna units.

FIG. 6 is a perspective view in which the first and second antenna units of FIG. 5 are arranged on a printed circuit board (PCB).

FIG. 7 shows antenna performance changes according to changes in a height, a gap to a roof made of a metal material, and a width with respect to the first antenna unit.

FIG. 8 shows the first antenna unit arranged on a dielectric carrier.

FIG. 9 illustrates a conceptual diagram and a side view in which first to third antenna units are arranged on the PCB.

FIG. 10 illustrates a structure in which the second and third antenna units of FIG. 9 are arranged on the dielectric carrier.

FIG. 11 is a side view of the antenna assembly in which the first antenna unit having first to fourth connection patterns, and the second and third antenna units are arranged on the PCB.

FIG. 12 illustrates a front perspective view and a rear perspective view in which the first to third antenna units of FIG. 11 are arranged on the PCB.

### MODE FOR THE INVENTION

Hereinafter, embodiments disclosed herein will be described in detail with reference to the accompanying drawings, and the same or similar elements are designated with the same numeral references, regardless of the numerals in the drawings, and their redundant description will be omitted. Suffixes “module” and “unit” used for components used in the following description are merely intended for easy description of this specification, and each suffix itself is not intended to give any special meaning or function. In describing the embodiments disclosed herein, moreover, the detailed description will be omitted when specific description for publicly known technologies to which this specification pertains is judged to obscure the gist of the present disclosure. The accompanying drawings are used to help easily understand the technical idea of this specification and it should be understood that the idea of this specification is not limited by the accompanying drawings. The idea of this specification should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected” or “coupled” to another element, the element may be directly connected or coupled to the another element, or intervening elements may also be present. In contrast, when an element is referred to as being “directly connected with” another element, there are no intervening elements present.

A singular representation may include a plural representation unless it represents a definitely different meaning from the context.

Terms such as “include” or “has” as used herein should be understood that they are intended to indicate the existence of a feature, a number, a step, an element, a component, or a combination thereof disclosed in this specification, and it may also be understood that a possibility of presence or addition of one or more other features, numbers, steps, elements, components, or combinations thereof are not excluded in advance.

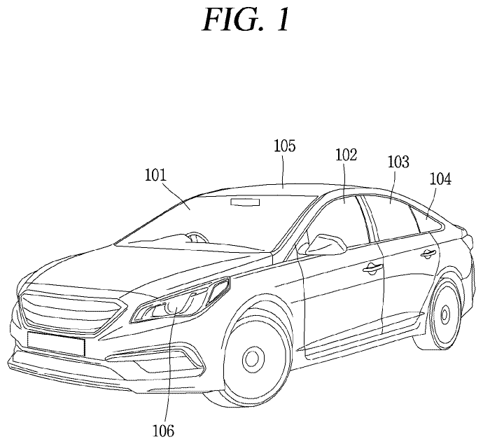

Hereinafter, a transparent antenna module according to this specification and a method of manufacturing the same are described in detail. In this regard, FIG. 1 is a diagram illustrating a vehicle according to an embodiment of this specification.

Referring to FIG. 1, a vehicle 1 may include at least one communication antenna. The vehicle 1 may transmit and/or receive signals of various frequency bands using the communication antenna. The vehicle 1 may perform communications such as vehicle-to-vehicle (V2V), vehicle to infrastructure (V2I), vehicle-to-pedestrian (V2P), vehicle-to-network (V2N), and the like.

The antenna may include a substrate made of a material such as olyethylene terephthalate (PET), and an antenna pattern arranged on the substrate. For example, the antenna may be a transparent antenna.

The antenna may also be placed on glass of the vehicle 1. The antenna may be combined with or attached to a front windshield 101, door glass 102 and 103, quarter glass 104, a rear windshield (not illustrated), a side mirror (not illustrated), a sunroof 105, or lamp glass 106. For example, the antenna may be a transparent antenna. As another example, the antenna may be placed in a region in which a roof 110 on the vehicle 1 is arranged.

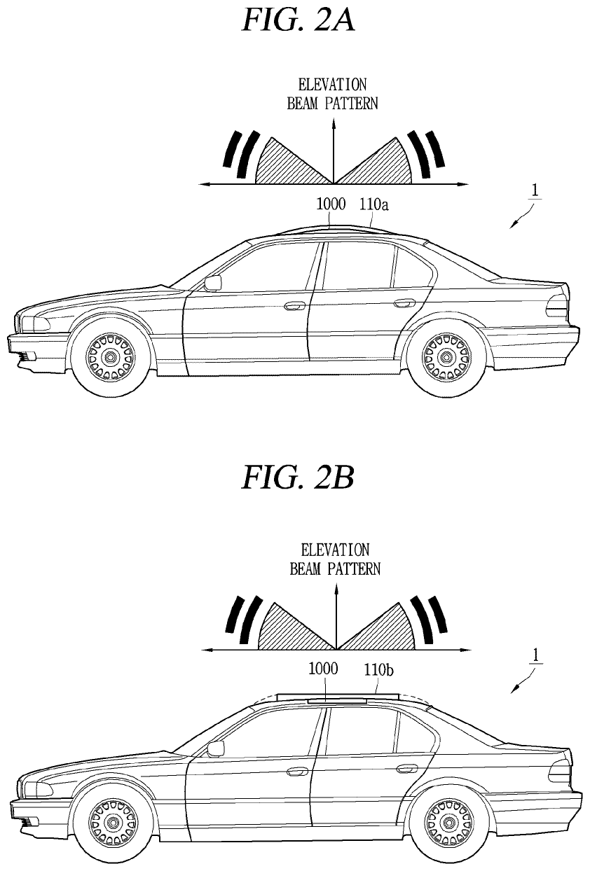

Meanwhile, FIGS. 2A to 2B illustrate a structure in which an antenna assembly may be mounted on a vehicle according to this specification, wherein the vehicle includes the antenna assembly.

Referring to FIGS. 2A to 2B, in this specification, to improve an appearance of the vehicle and maintain telematics performance during collision, a general shark fin antenna is replaced with a flat antenna having a non-protruding shape. In addition, this specification proposes an antenna in which a long term evolution (LTE) antenna and a fifth generation (5G) antenna are integrated in consideration of 5G communications along with provision of a general mobile communication service (LTE).

Referring to FIG. 2A, an antenna system 1000 is arranged on a roof placed on the vehicle 1. In FIG. 2A, a radome 110a configured to protect the antenna system 1000 from an external environment and external impacts while the vehicle travels may surround the antenna system 1000. The radome 110a may be made of a dielectric material capable of transmitting a wireless signal sent/received between the antenna system 1000 and an infrastructure such as a base station or other vehicles.

Referring to FIG. 2B, the antenna system 1000 may be arranged within a roof structure 110b of the vehicle 1, and at least a part of the roof structure 110b may be configured to be implemented with a non-metallic material. At this time, at least a part of the roof structure 110b of the vehicle may be implemented with a non-metallic material to include a dielectric material capable of transmitting a wireless signal sent to/received from the antenna system 1000 and an infrastructure such as a base station or other vehicles.

Meanwhile, referring to FIGS. 2A and 2B, a region in which a beam pattern is generated by an antenna included in the antenna system 1000 mounted on the vehicle needs to extend to an area located upward by a predetermined angle from a horizontal region.

In this regard, a peak of an elevation beam pattern of the antenna included in the antenna system 1000 does not need to be aligned within a boresight. Therefore, the peak of the elevation beam pattern of the antenna needs to be generated up to an area located upward by a predetermined angle from a horizontal region. For example, the elevation beam pattern of the antenna may be generated in a hemisphere shape as shown in FIGS. 2A and 2B. Additionally, since a beam peak is generated within a range of a low elevation angle (e.g., 30 degrees), the elevation beam pattern of the antenna may be referred to as a low elevation beam pattern.

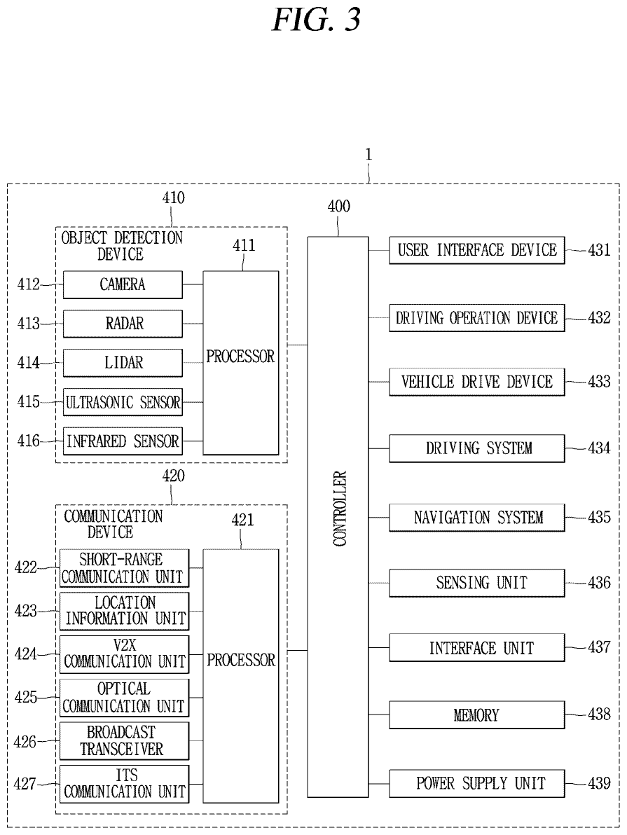

FIG. 3 is a configuration diagram of the vehicle according to an embodiment of this specification. Referring to FIG. 3, the vehicle 1 may include an object detection device 410, a communication device 420, a user interface device 431, a driving operation device 432, a vehicle drive device 433, a driving system 434, a navigation system 435, a sensing unit 436, an interface unit 437, a memory 438, a power supply unit 439, and/or a controller 440. On the other hand, the vehicle 1 may further include components other than the components described above, or some of the components described above may not be included.

The object detection device 410 may be a device configured to detect an object located outside the vehicle 1. For example. the object detection device 410 may include a processor 411, a camera 412, a radar 413, a LiDAR 414, an ultrasonic sensor 415, and/or an infrared sensor 416.

The communication device 420 may be a device configured to perform communication with an external device. The communication device 420 may include at least one among a transmitting antenna, a receiving antenna, and a radio frequency (RF) circuit or an RF element capable of implementing various communication protocols to perform communication. For example, the communication device 420 may include a processor 421, a short-range communication unit 422, a location information unit 423, a vehicle-to-everything (V2X) communication unit 424, an optical communication unit 425, a broadcast transceiver 426 and/or an ITS communication unit 427.

The user interface device 431 may be a device configured to allow an interaction between the vehicle 1 and a user. The vehicle 1 may implement a user interface (UI) or a user experience (UX) through the user interface device 431.

The driving operation device 432 may be a device configured to receive a user input for driving. The vehicle drive device 433 may be a device configured to electrically control drive of various devices within the vehicle 1. The driving system 434 may be a system configured to control various driving operations of the vehicle 1. The navigation system 435 may provide navigation information. The sensing unit 436 may sense a state of the vehicle 1.

The interface unit 437 may function as an interface with various types of external devices connected to the vehicle 1. The memory 438 may store basic data for units of the vehicle 1, control data for controlling operations of the units, input or output data, and the like. The power supply unit 439 may supply power needed for operations of respective components. The controller 440 may control all operations of each unit within the vehicle 1. The controller 440 may be implemented as an electronic control unit (ECU) and/or a telematics control unit (TCU).

Meanwhile, referring to FIGS. 1 to 3, the antenna system mounted on the vehicle may be arranged inside the vehicle, on a roof of the vehicle, inside the roof, or inside a roof frame. In this regard, the antenna system disclosed herein may be configured to operate in a low band (LB), a mid band (MB), and a high band (HB) of a 4G LTE system and a SUB6 band of a 5G NR system.

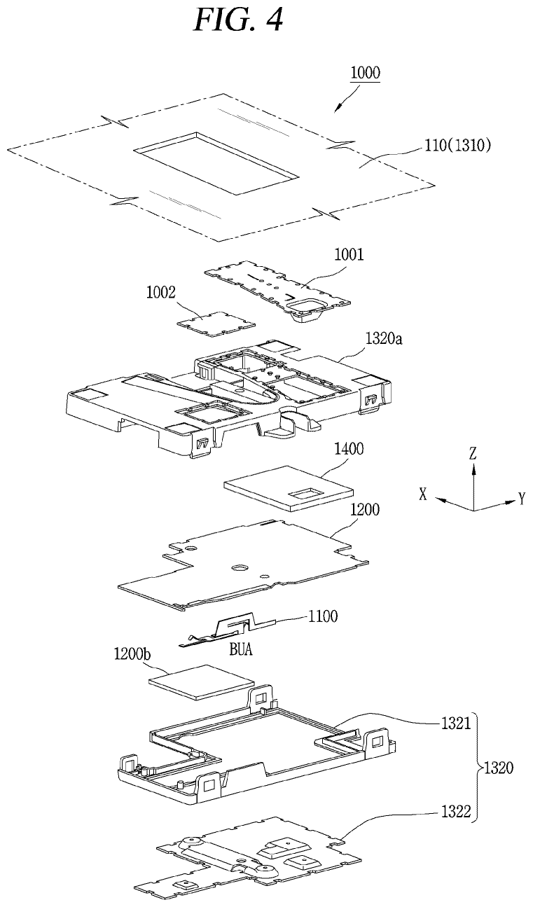

Hereinafter, the antenna assembly mounted on the vehicle according to this specification will be described. In this regard, FIG. 4 is an exploded view of the antenna assembly mounted on the vehicle according to this specification.

Referring to FIG. 4, an antenna assembly 1000 may be arranged in a region below the roof 110 having a metal material and located on the vehicle. A metal region may be partially removed from a region of the roof 110 in which the antenna assembly 1000 is located, and a dielectric region may be arranged in the region.

The antenna assembly 1000 may include a first cover 1320a which is an upper cover and a second cover 1320 which is a lower cover. The roof 110 having a metal material may correspond to a first housing 1310, and the second cover 1320 which is the lower cover may correspond to a second housing 1320. The antenna assembly 1000 may include an antenna 1100, a printed circuit board (PCB) 1200, and electronic components each arranged in a space between the first cover 1320a and the second cover 1320.

Metal structures 1001 and 1002 may be coupled into an opening region of the first cover 1320a. The metal structures 1001 and 1002 may perform as a heat sink configured to prevent heat absorbed into an inner side through the roof 110 of the vehicle from being absorbed into the antenna assembly 1000.

The antenna 1100 may be arranged on a first region of the PCB 1200. The network access device (NAD) 1400 may be arranged on a second region of the PCB 1200. The NAD 1400 is operatively coupled to the antenna 1100 and controls operation of the antenna 1100 and the electronic components, and thus may be referred to as a processor.

The first region and the second region of the PCB 1200 may be a left region and a right region with reference to one axis (Y-axis) of the PCB 1200, respectively, but are not limited thereto. The antenna 1100 may be arranged in a lower end region of the first region of the PCB 1200. The antenna 1100 may be configured to operate when an antenna (not shown) arranged on the roof 110 does not operate. Accordingly, the antenna 1100 may also be referred to as a backup antenna BUA.

A module PCB 1200b may be arranged on a rear surface of the PCB 1200. The second cover 1320, which is the lower cover, may include a coupling frame 1321 and a metal structure 1322. The coupling frame 1321 may be configured to be coupled to the first cover 1320a which is the upper cover. The metal structure 1322 may be combined into an inner space of the coupling frame 1321. The metal structure 1322 of the second cover 1320 which is the lower cover may operate as a heat sink configured to discharge heat generated inside the antenna assembly 1000 to a vehicle body and an outer side.

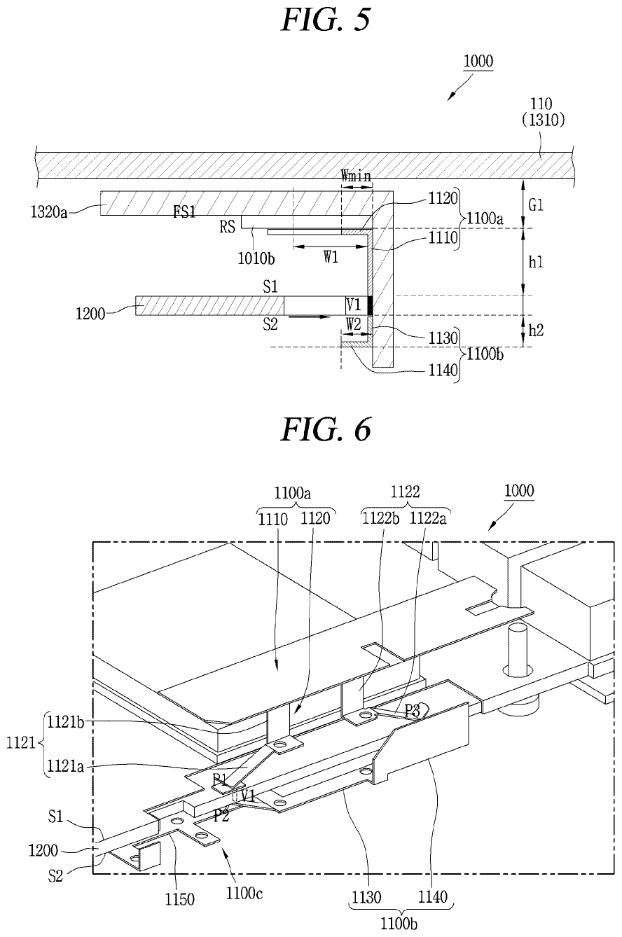

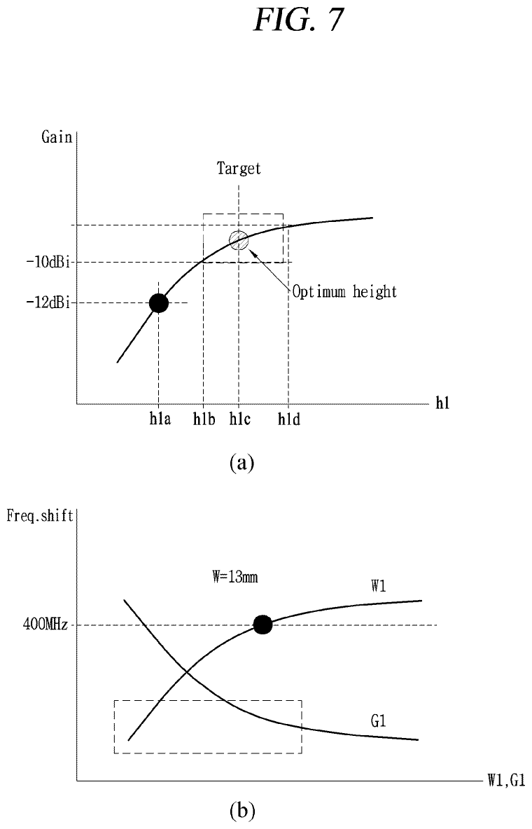

Meanwhile, FIG. 5 is a side view of the antenna assembly having first and second antenna units. FIG. 6 is a perspective view in which the first and second antenna units of FIG. 5 are arranged on the PCB.

Referring to FIGS. 4 to 6, the antenna assembly 1000 mounted on the vehicle may be configured to include the first housing 1310, the second housing 1320, the PCB 1200, a first antenna unit 1100a, and a second antenna unit 1100b. The first antenna unit 1100a and the second antenna unit 1100b may operate as radiators in frequency bands for LTE (4G) or 5G communications. The antenna assembly 1000 may be configured to further include a third antenna unit 1100c. The third antenna unit 1100c may operate as a radiator in frequency bands for Wi-Fi communication.

The first housing 1310 may correspond to the roof 110 of FIG. 1 made of a metal material of the vehicle on which the antenna assembly 1000 is placed. Accordingly, the first housing 1310 may be configured as a first metal housing corresponding to the roof 110 of the vehicle. The second housing 1320 may correspond to the lower cover of the antenna assembly 1000. The second housing 1320 may be configured as a second metal housing to have at least a partial region implemented with a metal material. The PCB 1200, the first antenna unit 1100a, and the second antenna unit 1100b may be arranged in a space defined by a combination of the first housing 1310 and the second housing 1320.

The first antenna unit 1100a, the second antenna unit 1100b, and other electronic components may be arranged on the PCB 1200. The first antenna unit 1100a may be arranged between the first housing 1310 and the PCB 1200. The first antenna unit 1100a may be connected to a first point P1 on a first surface S1 of the PCB 1200. The second antenna unit 1100b may be arranged between the second housing 1320 and the PCB 1200. The second antenna unit 1100b may be connected to a second point P2 on a second surface S2 of the PCB 1200.

The first point P1 on the first surface S1 of the PCB 1200 may be connected to the second point P2 on the second surface S2 of the PCB 1200 by a via V1. The second point P2 may be arranged on the second surface S2 of the PCB 1200 to correspond to the first point P1 on the first surface S1 of the PCB 1200. In this regard, the via V1 may be configured to vertically connect the first point P1 on the first surface S1 of the PCB 1200 to the second point P2 on the second surface S2 of the PCB 1200.

The first antenna unit 1100a may be configured to include at least one metal pattern. The first antenna unit 1100a may include a conductive pattern 1110. The first antenna unit 1100a may be configured to include at least one connection pattern 1120. The antenna element 1100a may be configured to include the conductive pattern 1100 and the connection pattern 1120.

The conductive pattern 1110 may be configured to radiate a wireless signal in a first frequency band. The conductive pattern 1110 may be arranged inwardly from an end portion of the PCB 1200 to be parallel with the PCB 1200. The connection pattern 1120 may be connected to an end portion of the conductive pattern 1110 and the end portion of the PCB 1200. The connection pattern 1120 may be arranged to be vertical to the PCB 1200.

The first antenna unit 1100a may be connected to a plurality of connection patterns. The first antenna unit 1100a may be configured to include the conductive pattern 1100, a first connection pattern 1121, and a second connection pattern 1122. The conductive pattern 1110 may be configured to radiate a wireless signal in the first frequency band. The conductive pattern 1110 may be connected to at least one conductive pattern. The conductive pattern 1110 may be connected to the first connection pattern 1121 and the second connection pattern 1122. The conductive pattern 1110 may be arranged in a direction of a horizontal axis to be parallel with the PCB 1200.

The first connection pattern 1121 may be connected to the first point P1 on the first surface S1 of the PCB 1200. A portion 1121a of the first connection pattern 1121 may be arranged in the direction of the horizontal axis and a direction of a vertical axis from the first point P1. A remaining portion 1121b of the first connection pattern 1121 may be arranged to extend in the vertical axis direction. The horizontal axis may correspond to an X-axis or a Y-axis, and the vertical axis may correspond to a Z-axis.

The second connection pattern 1122 may be connected to a third point P3 on the first surface S1 of the PCB 1200. A portion 1122a of the second connection pattern 1122 may be arranged in the horizontal axis direction and the vertical axis direction from the third point P3. A remaining portion 1122b of the second connection pattern 1123 may be arranged to extend in the vertical axis direction.

The second antenna unit 1100b may be configured to include at least one metal pattern. The second antenna unit 1100b may be configured to include at least one among a second conductive pattern 1130 and a third conductive pattern 1140. The second antenna unit 1100b may be configured to include the second conductive pattern 1130 and the third conductive pattern 1140.

The second conductive pattern 1130 may have one end portion connected to the second point P2 on the second surface S2 of the PCB 1200. The second conductive pattern 1130 may extend in the horizontal axis direction to be arranged in parallel with the PCB 1200. The third conductive pattern 1140 may be connected to another end portion of the second conductive pattern 1130. The third conductive pattern 1140 may be arranged to extend in the vertical axis direction to be vertical to the PCB 1200.

The third antenna unit 1100c may be arranged between the second housing 1320 and the PCB 1200. The third antenna unit 1100c may be arranged in a space below the PCB 1200, the space being defined by the second surface S2 of the PCB 1200 and the second housing 1320. The third antenna unit 1100c may be configured to include a fourth conductive pattern 1150 arranged in parallel with the PCB 1200.

The first antenna unit 1100a and the second antenna unit 1100b may operate as radiators configured to radiate wireless signals in different frequency bands, respectively. The first antenna unit 1100a may operate as a radiator by radiating a wireless signal in the first frequency band. The second antenna unit 1100b may operate as a radiator by radiating a wireless signal in a second frequency band higher than the first frequency band. The third antenna unit 1100c may operate as a radiator configured to radiate a wireless signal in a Wi-Fi frequency band. The third antenna unit 1100c may operate as a radiator by radiating a wireless signal in a fourth frequency band higher than the second frequency band.

First to third frequency bands may be frequency bands for LTE (4G) or 5G communications. For example, the first frequency band may be a low band (LB) for 4G/5G communications, and the second frequency band may be a mid band (MB) for 4G/5G communications. The third frequency band may be a high band (HB) for 4G/5G communications. For example, the low band (LB) may be set to a band of 617 to 960 MHz which is below 1 GHz, and the mid band (MB) may be set to a 0.96 to 1.4 GHz band. The high band (HB) may be set to a 1.7 to 4.5 GHz band. The fourth frequency band may be set to at least one of a 2.4 GHz band and a 5 to 7 GHz band as a Wi-Fi frequency band.

The first antenna unit 1100a may be arranged on the first surface S1 of the PCB 1200 to have a first height h1. The conductive pattern 1120 of the first antenna unit 1100a may be spaced apart from the first housing 1310 by a first gap G1. The first antenna unit 1100a may have a first width W1 formed inwardly toward the PCB 1200. In this regard, the conductive pattern 1110 of the first antenna unit 1100a may have the first width W1 formed inwardly toward the PCB 1200.

Meanwhile, in the antenna assembly according to this specification, the height h1, the gap G1, and the width W1 of the first antenna unit 1100a may be optimized in relation to an antenna performance parameter. In this regard, FIG. 7 shows antenna performance changes according to changes in a height, a gap to the roof made of a metal material, and a width with respect to the first antenna unit.

(a) of FIG. 7 shows a graph of antenna gains Gain according to the height h1 of the first antenna unit. (b) of FIG. 7 shows a graph of frequency shifts Freq.shift according to the gap G1 from the first antenna unit to the roof.

Referring to FIGS. 4 to 6 and (a) of FIG. 7, as the height h1 of the first antenna unit 1100a increases, an antenna gain increases. For example, as the height h1 of the first antenna unit 1100a increases from h1a to h1b, an antenna gain increases from −12 dBi to −10 dBi. As the height h1 of the first antenna unit 1100a increases from h1b to h1c, an antenna gain increases from −10 dBi to −10 dB or greater. However, a rate at which an antenna gain increases is relatively small compared to a rate at which the height h1 of the first antenna unit 1100a increases.

In this regard, the first height h1 of the first antenna unit 1100a may be configured to be equal to or greater than a first threshold value associated with an antenna gain of a predetermined value or greater. As one example, the first height h1 of the first antenna unit 1100a may be selected to be equal to or greater than a value of h1a in association with an antenna gain of −12 dBi or greater. As another example, the first height h1 of the first antenna unit 1100a may be selected to be equal to or greater than a value of h1b in association with an antenna gain of −10 dBi or greater. Since an antenna gain linearly increases when the first height h1 of the first antenna unit 1100a increases to h1b, the first height h1 of the first antenna unit 1100a may be selected to be at least h1b or greater.

Meanwhile, the first height h1 of the first antenna unit 1100a may be selected to be equal to or less than a value of h1d at which an antenna gain is saturated. Accordingly, the first height h1 of the first antenna unit 1100a may be selected to be a value between h1b and h1d. The first height h1 of the first antenna unit 1100a may be selected to be a value of h1c between h1b and h1d to satisfy a target antenna gain. For example, the first height h1 of the first antenna unit 1100a may be selected to be a value within a predetermined range with reference to 8.8 mm.

Referring to FIGS. 4 to 6 and (b) of FIG. 7, as the gap G1 from the first antenna unit 1100a to the roof increases, a frequency shift decreases, thereby reducing an influence of the roof made of a metal material. When the gap G1 from the first antenna unit 1100a to the roof is less than or equal to a value of G1a, a frequency shift in the low band (LB) increases to 400 MHz or greater.

As the width W1 of the first antenna unit 1100a decreases, coupling between the roof made of a metal material and the conductive pattern 1110 arranged in parallel with the roof decreases. Accordingly, as the width W1 of the first antenna unit 1100a decreases, the coupling between the conductive pattern 1110 and the roof decreases and a frequency shift also decreases. When the width W1 of the first antenna unit 1100a increases to 13 mm or greater, a frequency shift in the low band (LB) increases to 400 MHz or greater.

The increase in the width W1 of the first antenna unit 1100a has a greater influence on a decrease in a resonant frequency due to an increase in an electrical length of the first antenna unit 1100a compared to an influence on a coupling effect. In this regard, when the width W1 of the first antenna unit 1100a increases to 13 mm or greater, a value of a frequency shift according to a decrease in a resonant frequency is decreased relatively less compared to a rate at which the width W1 increases. Therefore, even when the width W1 of the first antenna unit 1100a is significantly increased to a value of 13 mm or greater, an effect of a resonant frequency shift is decreased due to the coupling with the roof having a metal material.

In this regard, the first gap G1 of the first antenna unit 1100a may be configured to be equal to or greater than a second threshold value associated with a minimum operating frequency of a predetermined value or less. The minimum operating frequency of the low band (LB) may be selected to be 617 MHz, but is not limited thereto. For example, the first gap G1 of the first antenna unit 1100a may be selected to have a value of 0.6 mm or greater. Meanwhile, the first gap G1 of the first antenna unit 1100a may be selected to have a minimum value among selectable values to minimize a height from the roof of the vehicle. Therefore, the first gap G1 of the first antenna unit 1100a may be selected to have a value of 0.6 mm.

The first width W1 of the first antenna unit 1100a may be configured to be equal to or greater than a third threshold value associated with a minimum operating frequency of a predetermined value or less. In this regard, a minimum value (Wmin) of the first width W1 may be selected to be 13 mm or greater so that a frequency shift linearly occurs as the first width W1 increases. For example, the first width W1 of the first antenna unit 1100a may be selected to have a value from among values of 13 mm or more within a predetermined range with reference to 13.3 mm.

The second conductive pattern 1130 of the second PCB 1100b may be located on the second surface S2 of the PCB 1200 to have a second height h2. The third conductive pattern 1140 of the second antenna unit 1100b may have a second width W2 formed inwardly toward the PCB 1200. As described above, since a second frequency band in which the second antenna unit 1100b operates is set to a frequency band higher than the first frequency band in which the first antenna unit 1100a operates, the second antenna unit 1100b may be implemented to have a smaller size than that of the first antenna unit 1100a. Accordingly, the second height h2 of the second metal structure 1100b may have a value smaller than a value of the first height h1 of the first antenna unit 1100a. In addition, since the first antenna unit 1100a and the second antenna unit 1100b are formed to have different heights, mutual interference may be reduced.

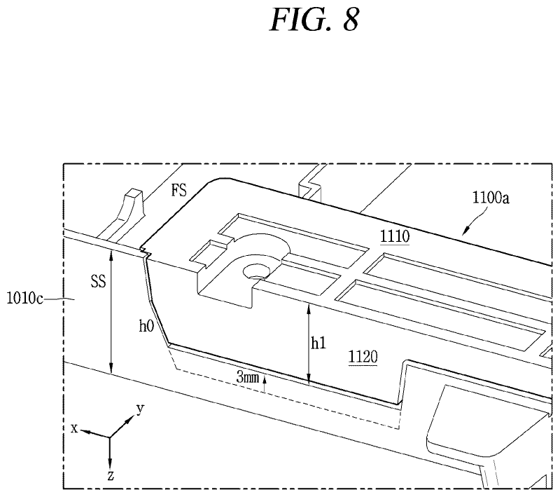

Meanwhile, the first antenna unit 1100a, the second antenna unit 1100b, and the third antenna unit 1100c of the antenna assembly 100 according to this specification may be implemented on a dielectric carrier. In this regard, FIG. 8 shows the first antenna unit arranged on the dielectric carrier of the antenna.

Referring to FIGS. 5 and 8, the first antenna unit 1100a may include a dielectric carrier 1010, the conductive pattern 1110, and the connection pattern 1120. The dielectric carrier 1010 may have one side surface SS and a front surface FS. The conductive pattern 1110 may be arranged on the front surface FS of the dielectric carrier 1010. The conductive pattern 1110 may be configured to include sub-regions having different heights in correspondence with a shape of the front surface FS of the dielectric carrier 1010. The conductive pattern 1110 may have a fixing hole to be fixed to the dielectric carrier 1010.

The connection pattern 1120 may be arranged on the one side surface SS of the dielectric carrier 1010. Accordingly, the first antenna unit 1100a arranged on the first dielectric carrier 1010 may constitute a first carrier antenna unit.

A height h1 of the connection pattern 1120 may correspond to the height h1 of the first antenna unit 1100a. A height h0 of the dielectric carrier 1010 needs to be reduced to a predetermined height or less to decrease a height of a whole system and/or increase rigidity of a mechanism that fixes the dielectric carrier 1010. For example, the height h0 of the dielectric carrier 1010 may be reduced from 15 mm to 12 mm by 3 mm. The height h1 of the connection pattern 1120 on the one side surface of the dielectric carrier 1010 having a height h0 of 12 mm may be implemented to have a value within a predetermined range with reference to 8.8 mm.

As another example, metal patterns of the first antenna unit 1100a may be arranged on the upper cover 1320a. Referring to FIG. 5, the conductive pattern 1110 may be arranged on an inner side FS1 of a front surface of the upper cover 1320 of the antenna assembly. The connection pattern 1120 may be arranged over one side surface SS1 of the inner side of the upper cover 1320. Meanwhile, a dielectric carrier 1010b may be arranged between the conductive pattern 1110 and the upper cover 1320a. In this regard, the conductive pattern 1110 may be arranged on a rear surface RS of the dielectric carrier 1010b, the rear surface RS being attached to the inner side FS1 on the front surface of the first cover 1320a which is the upper cover.

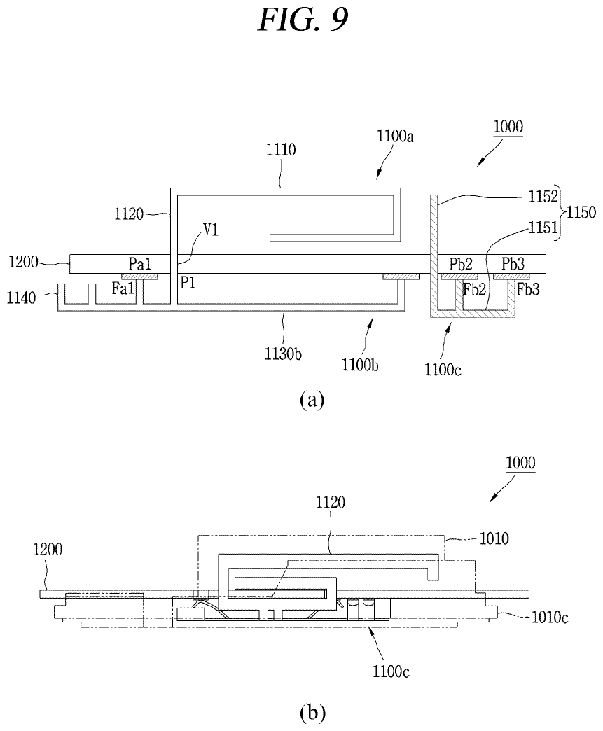

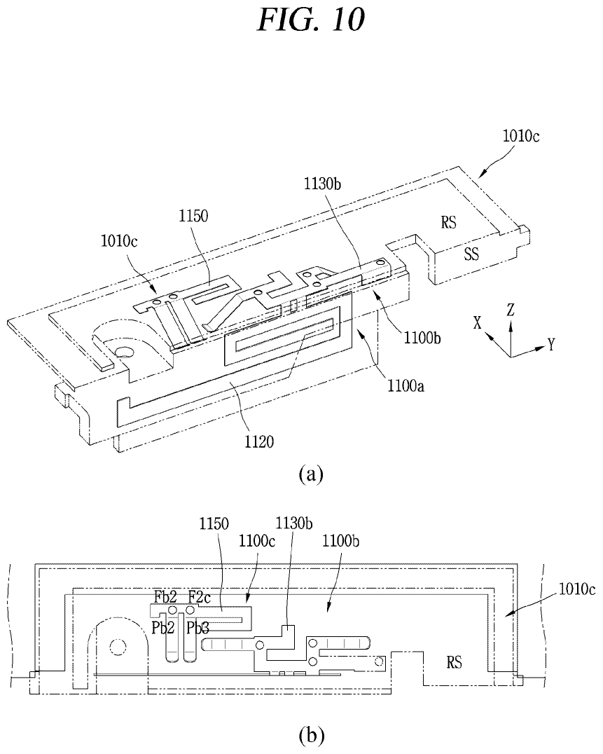

The second antenna unit 1100b may be arranged on the same dielectric carrier as the first antenna unit 1100a or may be arranged on a separate dielectric carrier. In this regard, FIG. 9 illustrates a conceptual diagram and a side view in which the first to third antenna units are arranged on the PCB. FIG. 10 illustrates a structure in which the second and third antenna units of FIG. 9 are arranged on the dielectric carrier.

(a) of FIG. 9 is a conceptual diagram of the antenna assembly 1000 having a structure in which the first to third antenna units 1100a, 1100b, and 1100c are connected to the PCB 1200. (b) of FIG. 9 is a side view of the antenna assembly 1000 in which the dielectric carrier 1010 is arranged in a region on the PCB 1200 and a second dielectric carrier 1010c is arranged in a region below the PCB 1200.

(a) of FIG. 10 is a perspective view of the second dielectric carrier 1010c having the first to third antenna units 1100a, 1100b, and 1100c arranged on one side surface and a rear surface thereof, respectively. (b) of FIG. 10 shows the second and third antenna units 1100b and 1100c arranged on the rear surface of the second dielectric carrier 1010c.

Referring to FIGS. 5, 9 and 10, the second antenna unit 1100b may be configured to include the second dielectric carrier 1010c and a second conductive pattern 1130b. Depending on implementations, the second antenna unit 1100b may be configured to further include the third conductive pattern 1140. The second antenna unit 1100b arranged on the second dielectric carrier 1010c may constitute a second carrier antenna unit.

The first and second antenna units 1100a and 1100b may be arranged to overlap each other by a predetermined length or more in one axis direction. With respect to the first antenna unit 1100a, only the connection pattern 1120 is shown. However, the conductive pattern 1110 may be arranged on a front surface of a separate dielectric carrier or the second dielectric carrier 1010c. The connection pattern 1120 of the first antenna unit 1100a may be arranged to overlap the second conductive pattern 1130b of the second antenna unit 1100b by a predetermined length or more in a Y-axis direction. The second conductive pattern 1130b of the second antenna unit 1100b may be arranged to overlap the fourth conductive pattern 1150 of the third antenna unit 1100c by a predetermined length or more in the Y-axis direction.

The second antenna unit 1100b arranged in the region below the PCB 1200 in the Z-axis direction, which is a vertical axis, may be connected to the first antenna unit 1100a arranged in the region on the PCB 1200 at the first point P1 by the via V1. A signal may be applied to the second antenna unit 1100b at a first feed point Pa1 through a first feed portion Fa1. A first signal of the first frequency band or the second frequency band may be applied to the second conductive pattern of the second antenna unit 1100b through the first feed portion Fa1 at the first feed point Pa1 to which the via V1 is connected.

Meanwhile, the antenna assembly according to this specification may further include the third antenna unit 1100c operating in a Wi-Fi frequency band. Referring to FIGS. 4, 5, 9 and 10, the third antenna unit 1100c may be arranged between the second housing 1320 and the PCB 1200. The third antenna unit 1100c may be configured to radiate a wireless signal in the fourth frequency band higher than the second frequency band. The second frequency band may be set to a 0.96 to 1.4 GHz band as a mid-band (MB) for 4G/5G communications. The fourth frequency band may be set to at least one of a 2.4 GHz band and a 5 to 7 GHz band as a Wi-Fi frequency band.

The third antenna unit 1100c may include the fourth conductive pattern 1150. The fourth conductive pattern 1150 may be arranged in the region below the PCB 1200 to be parallel therewith in the vertical axis direction of the PCB 1200. The fourth conductive pattern 1150 of the third antenna unit 1100c may include a first portion 1151 arranged in the region below the PCB 1200 and a second portion 1152 arranged in the region on the PCB 1200 in the vertical axis direction.

The third antenna unit 1100 c may be configured to perform dual resonance in the 2.4 GHz band and the 5 to 7 GHz band. For this configuration, signals of the fourth frequency band may be dual-fed to the fourth conductive pattern 1150 through a second feed portion Fb2 at a second feed point Pb2 and a third feed portion Fb3 at a third feed point Pb3 adjacent to the second feed point Pb2 in one axis direction. A second signal and a third signal may be dual-fed and applied to the fourth conductive pattern 1150 through the second feed portion Fb2 at the second feed point Pb2 and through the third feed portion Fb3 at the third feed point Pb3, respectively.

Center portions of the first and second antenna units 1100a and 1100b may be arranged to be spaced apart from each other in one axis direction. The connection pattern 1120 of the first antenna unit 1100a may be arranged to be spaced apart from the second conductive pattern 1130c of the second antenna unit 1100b by a predetermined length or greater in the Y-axis direction. The connection pattern 1120 of the first antenna unit 1100a may be implemented in a loop shape in which a plurality of conductive lines are arranged to overlap each other.

The second dielectric carrier 1010c may have one side surface SS and a rear surface RS. The second conductive pattern 1130b may be arranged on a rear surface of the second dielectric carrier 1010c. The third conductive pattern 1140 may be connected to the second conductive pattern 1130b. The second antenna unit 1100b including the second conductive pattern 1130b and the third conductive pattern 1140 may be arranged in the region below the PCB 1200. The second antenna unit 1100b arranged on the second dielectric carrier 1010c may constitute the second carrier antenna unit.

At least a portion of the first antenna unit 1100a may be arranged on the second dielectric carrier 1010c. In this regard, the connection pattern 1120 of the first antenna unit 1100a may be arranged on the one side surface SS of the second dielectric carrier 1010c. The conductive pattern 1110 of the first antenna unit 1100a may be arranged on the front surface of the dielectric carrier 1010c or a front surface on an inner side of another dielectric carrier.

When a shark fin antenna arranged on the vehicle roof does not operate, the first antenna unit 1100a may operate as the backup antenna BUA operating in the low band (LB). The first antenna unit 1100a may be configured to operate in the first frequency band which is the low band (LB). Additionally, the first antenna unit 1100a may be configured to operate in the first frequency band, which is the low band (LB), and the second frequency band, which is the middle band (MB).

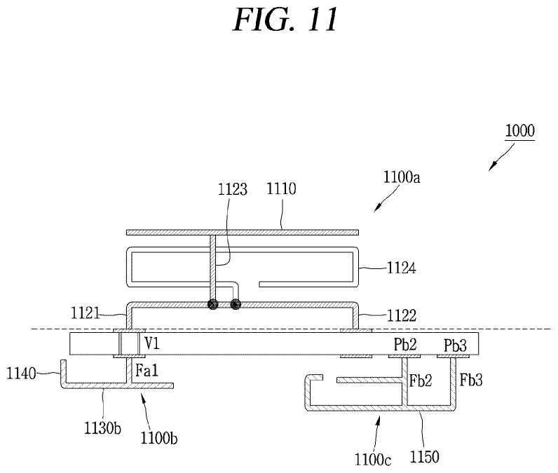

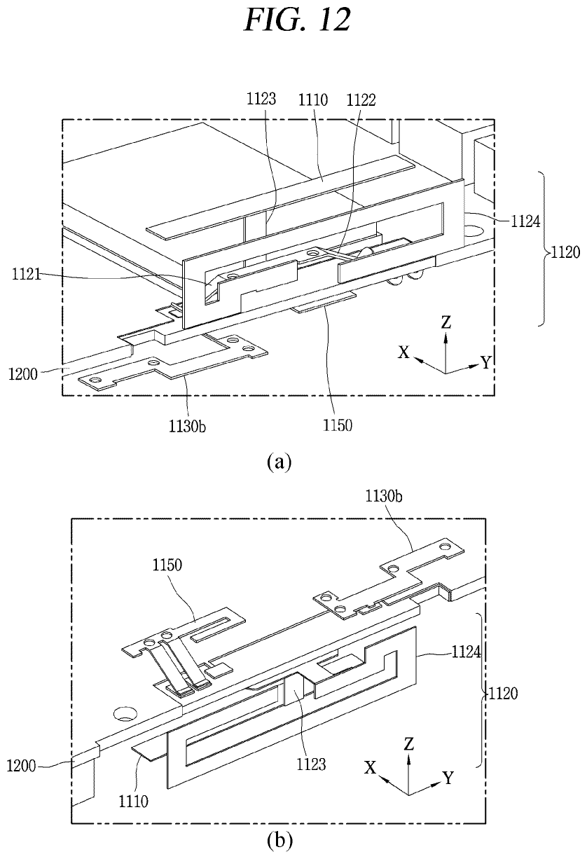

Meanwhile, the first antenna unit 1100a of the antenna assembly according to this specification may be implemented to have a modified connection pattern to allow the first antenna unit 1100a to operate in the low band (LB) and the middle band (MB). In this regard, FIG. 11 is a side view of the antenna assembly in which the first antenna unit having first to fourth connection patterns, and the second and third antenna units are arranged on the PCB. FIG. 12 illustrates a front perspective view and a rear perspective view in which the first to third antenna units of FIG. 11 are arranged on the PCB.

FIG. 11 is a side view of the antenna assembly in which the first antenna unit 1100a having first to fourth connection patterns 1121 to 1124 and the second and third antenna units 1100b and 1100c are arranged on the PCB 1200.

(a) of FIG. 12 is a front perspective view in which the first to third antenna units 1100a, 1100b, and 1100c of FIG. 11 are arranged on the PCB. (b) of FIG. 12 is a rear perspective view in which the first to third antenna units 1100a, 1100b, and 1100c of FIG. 11 are arranged on the PCB.

Referring to FIGS. 4, 5, 11, and 12, the first antenna unit 1100a operates to radiate a wireless signal in the first frequency band, which is the low band (LB), and the second frequency band, which is the middle band (MB). The second antenna unit 1100b operates to radiate a wireless signal in the second frequency band. Accordingly, the antenna 1100 including the first antenna unit 1100a and the second antenna unit 1100b may operate in a wider band in the second frequency band to thereby improve an antenna gain. Meanwhile, when a termination portion such as a 50 ohm resistor is formed by replacing the second antenna unit 1100b, the antenna 1100 implemented as the first antenna unit 1100a may operate to radiate a wireless signal up to the third frequency band which is the high band (HB).

The first antenna unit 1100a may be configured to include the conductive pattern 1110, the first connection pattern 1121, the second connection pattern 1122, the third connection pattern 1123, and the fourth connection pattern 1124.

The first connection pattern 1121 may be connected to the first point P1 on the first surface S1 of the PCB 1200. A portion of the first connection pattern 1121 may be arranged to be inclined in a YZ-axis direction, and a remaining portion thereof may extend in the Y axis direction which is the horizontal axis direction. The second connection pattern 1122 may be connected to the third point P3 on the first surface S1 of the PCB 1200. A portion of the second connection pattern 1122 may be arranged to be inclined in the YZ-axis direction, and a remaining portion thereof may extend in the Y axis direction which is the horizontal axis direction.

The third connection pattern 1123 may be connected to an end portion of the first connection pattern 1121 and an end portion of the second connection pattern 1122 each extending in the horizontal axis direction. The end portion of the first connection pattern 1121 and the end portion of the second connection pattern 1122 may be arranged at one point. The third connection pattern 1123 may extend in the Z-axis direction which is the vertical axis direction.

The fourth conductive pattern 1124 may be connected to the end portion of the first connection pattern 1121 and the end portion of the second connection pattern 1122. The fourth conductive pattern 1124 may be arranged on a plane vertical to the PCB 1200. The fourth connection pattern 1124 may be configured in a loop shape in which a plurality of conductive lines overlap each other in the Y-axis direction which is the one axis direction.

The antenna assembly mounted on the vehicle has been described above. The technical effects of the antenna assembly having mounted on the vehicle and the vehicle mounted with the antenna assembly are described as follows.

According to this specification, a gap distance between a first antenna unit arranged in a region on the PCB and a metal structure may be adjusted to resolve antenna performance deterioration caused by a vehicle body or roof.

According to this specification, a gap distance between the first antenna unit and the metal structure and a width and a height of the first antenna unit may be adjusted to maintain antenna performance at a certain level even when exterior of the vehicle body or roof is made of a metal material.

According to this specification, an antenna gain may be maintained at a certain level or greater while minimizing a gap distance between the first antenna unit and the metal structure to thereby enhance antenna performance while maintaining a height of the antenna assembly at a certain level or less.

According to this specification, the first to third antenna units may be arranged in regions on and below the PCB, respectively, so that the antenna assembly may operate in multiple frequency bands for 4G/5G communications and Wi-Fi frequency bands.

According to this specification, a gap distance, and a width and a height of the first antenna unit may be implemented to have threshold values or less to thereby optimize parameters of an antenna arranged on a region of the vehicle roof while taking into account antenna gains and frequency characteristics.

Further scope of applicability of the present disclosure will become apparent from the following detailed description. It should be understood, however, that the detailed description and specific examples, such as the preferred embodiment of the present disclosure, are given by way of illustration only, since various changes and modifications within the idea and scope of the present disclosure will be apparent to those skilled in the art. The detailed description should not be limitedly construed in all of the aspects, and should be understood to be illustrative. The scope of the present disclosure should be determined by reasonable interpretation of the appended claims, and all changes within the scope of equivalents of the present disclosure are included in the scope of the present disclosure.

1. An antenna assembly mounted on a vehicle, the antenna assembly comprising:
a first housing;
a second housing;
a printed circuit board (PCB) on which electronic components are arranged;
a first antenna unit arranged between the first housing and the PCB and connected to a first point on a first surface of the PCB; and
a second antenna unit arranged between the second housing and the PCB and connected to a second point on a second surface of the PCB,
wherein the first point and the second point are connected to each other by a via,
wherein the first antenna unit comprises:
a dielectric carrier having one side surface and a front surface;
a conductive pattern located on the front surface of the dielectric carrier and arranged inwardly from an end portion of the PCB to be parallel with the PCB; and
a connection pattern located on the one side surface of the dielectric carrier, arranged vertically to the PCB, and connecting an end portion of the conductive pattern to the end portion of the PCB,
wherein the first antenna unit is arranged on the first surface of the PCB to have a first height,
the conductive pattern of the first antenna unit is spaced apart from the first housing by a first gap,
the first height has a value equal to or greater than a first threshold value associated with an antenna gain of a predetermined value or greater, and
the first gap has a value equal to or greater than a second threshold value associated with a minimum operating frequency of a predetermined value or less.

2. The antenna assembly of claim 1, wherein the first antenna unit comprises:
a first connection pattern connected to the first point and extending in a vertical axis direction;
a second connection pattern connected to a third point on the first surface of the PCB and extending in the vertical axis direction; and
the conductive pattern connected to the first connection pattern and the second connection pattern and arranged in parallel with the PCB.

3. The antenna assembly of claim 1, wherein the first antenna unit comprises:
a first connection pattern connected to the first point and extending in a horizontal axis direction;
a second connection pattern connected to a third point on the first surface of the PCB and extending in the horizontal axis direction;
a third connection pattern connected to an end portion of the first connection pattern and an end portion of the second connection pattern each extending in the horizontal axis direction, and extending in a vertical axis direction;
a fourth connection pattern connected to the end portion of the first connection pattern and the end portion of the second connection pattern and having a loop shape defined on a plane thereof vertical to the PCB; and
the conductive pattern connected to the third connection pattern and arranged in parallel with the PCB.

4. The antenna assembly of claim 2, wherein the second antenna unit comprises:
a second dielectric carrier having one side surface and a rear surface; and
a second conductive pattern arranged on the rear surface of the second dielectric carrier, and
wherein the first antenna unit constitutes a first carrier antenna unit, and the second antenna unit constitutes a second carrier antenna unit,
wherein the second conductive pattern has one end portion connected to the second point and extends in a horizontal axis direction to be arranged in parallel with the PCB, and
the second antenna unit comprises a third conductive pattern connected to another end portion of the second conductive pattern and extending in the vertical axis direction to be arranged vertically to the PCB.

5. The antenna assembly of claim 4, wherein the first antenna unit operates in a first frequency band,
the second antenna unit operates in a second frequency band higher than the first frequency band, and
the first frequency band and the second frequency band are frequency bands for long-term evolution (LTE) or fifth generation (5G) communications.

6. The antenna assembly of claim 4, wherein the first housing is configured as a first metal housing corresponding to a roof of the vehicle, and
the second housing is configured as a second metal housing corresponding to a lower cover of the antenna unit.

7. (canceled)

8. The antenna assembly of claim 6, wherein the first antenna unit has a first width formed inwardly toward the PCB, and
the first width has a value equal to or greater than a third threshold value associated with the minimum operating frequency.

9. The antenna assembly of claim 6, wherein the second conductive pattern of the second antenna unit is located on the second surface of the PCB to have a second height,
the third conductive pattern of the second antenna unit has a second width formed inwardly toward the PCB, and
the second height has a value smaller than a value of the first height.

10. The antenna assembly of claim 1, wherein the conductive pattern is located on an inner side of a front surface of an upper cover of the antenna assembly or arranged on the rear surface of the dielectric carrier, the rear surface being attached to the inner side of the front surface of the upper cover, and
the connection pattern is arranged over one side surface of the inner side of the upper cover.

11. The antenna assembly of claim 5, further comprising a third antenna unit arranged between the second housing and the PCB and configured to radiate a wireless signal in a fourth frequency band higher than the second frequency band, and
the third antenna unit comprises a fourth conductive pattern arranged in parallel with the PCB.

12. The antenna assembly of claim 11, wherein a first signal is applied to the second conductive pattern of the second antenna unit at a first feed point through a first feed portion, and
a second signal is dual-fed and applied to the fourth conductive pattern through a second feed portion at a second feed point, and a third signal is dual-fed and applied to the fourth conductive pattern through a third feed portion at a third feed point adjacent to the second feed point in one axis direction.
